(19) United States
(12) Patent Application Publication
(10) Pub. No.: US 2020/0286452 A1
(43) Pub. Date: Sep. 10, 2020

(54) AGENT DEVICE, AGENT DEVICE CONTROL METHOD, AND STORAGE MEDIUM

(71) Applicant: HONDA MOTOR CO., LTD., Tokyo (JP)

(72) Inventors: Mototsugu Kubota, Wako-shi (JP); Hiroki Nakayama, Wako-shi (JP); Sawako Furuya, Wako-shi (JP)

(21) Appl. No.: 16/808,415

(22) Filed: Mar. 4, 2020

(30) Foreign Application Priority Data
Mar. 8, 2019 (JP) 2019-042917

(51) Int. Cl. G09G 5/38; G10L 15/22; G06F 3/16; G06T 13/80; G09G 5/37

(52) U.S. Cl. CPC G09G 5/38; G10L 15/22; G06F 3/167; G10L 2015/223; G09G 5/37; G09G 2354/00; G06T 13/80

(57) ABSTRACT

There is provided an agent device, including an agent functional unit configured to provide a service including causing an output unit to output a response using a voice, in response to an utterance of an occupant in a vehicle; and a display controller configured to cause a display provided in the vehicle to display an animation related to an agent corresponding to the agent functional unit, wherein the display controller is configured to cause the display to display the animation in different types between a case where the animation is displayed in a first display area of the display, and a case where the animation is displayed in a second display area which is different from the first display area.

### CROSS-REFERENCE TO RELATED APPLICATION

Priority is claimed on Japanese Patent Application No. 2019-042917, filed Mar. 8, 2019, the content of which is incorporated herein by reference.

### BACKGROUND

### Field of the Invention

The present invention relates to an agent device, an agent device control method, and a storage medium.

### Description of Related Art

In the related art, a technology related to an agent function which provides information related to driving assistance in response to a request from an occupant, vehicle control, other applications, and the like while performing conversation with the occupant in a vehicle is disclosed (Japanese Unexamined Patent Application, First Publication No. 2006-335231).

### SUMMARY

In recent years, practical applications of mounting of agents and agent functions in vehicles have been promoted, but display types used when agent functions are activated have not been sufficiently studied. Therefore, in the related art, it is not possible to perform display in an appropriate mode in some cases.

The present invention has been made in view of such circumstances, and an object of the present invention is to provide an agent device, an agent device control method, and a storage medium through which it is possible to realize in-vehicle displays in an appropriate mode when an agent provides an agent function.

The agent device, agent device control method, and storage medium according to the invention have the following configurations.

(1) According to an aspect of the invention, there is provided an agent device which includes an agent functional unit configured to provide a service including causing an output unit to output a response using a sound, in response to an utterance of an occupant in a vehicle; and a display controller configured to cause a display provided in the vehicle to display an animation related to an agent corresponding to the agent functional unit, wherein the display controller is configured to cause the display to display the animation in different types between a case where the animation is displayed in a first display area of the display, and a case where the animation is displayed in a second display area which is different from the first display area.
(2) In the aspect (1), a position of the first display area in the vehicle is closer to a position at which a driver's head is assumed to be located than the second display area.
(3) In the aspect (1), the display controller causes the display to display an animation of the agent in a simpler mode when the animation of the agent is displayed in the first display area than when the animation of the agent is displayed in the second display area.
(4) In the aspect (3), according to an utterance of the occupant, the display controller causes the display to display an animation of the agent in a simpler mode when the animation of the agent is displayed in the first display area than when the animation of the agent is displayed in the second display area.
(5) In the aspect (3), the simple mode includes a mode with little movement.
(6) In the aspect (1), the display controller changes at least one of a display position and a display type of the animation according to a driving situation of the vehicle.
(7) In the aspect (1), the display controller causes the display to display agent information that is provided in response to an utterance of the occupant, and display the agent information in different types between display in the first display area and display in the second display area.
(8) In the aspect (7), the display controller reduces the amount of information when the agent information is displayed in the first display area compared to when the agent information is displayed in the second display area.
(9) In the aspect (7), when a part of the agent information displayed in the second display area is designated by the occupant using an operation unit, the display controller changes the display of the first display area to information based on the part of the agent information designated by the occupant.
(10) In the aspect (1), the agent functional unit acquires a seat position of the occupant who has produced the utterance in the vehicle, and the display controller causes, based on the position of the seat of the occupant who has produced the utterance in the vehicle, the animation to be displayed in a display area closer to a position at which the head of the occupant who has produced the utterance is assumed to be located between the first display area and the second display area.
(11) In the aspect (10), the display controller causes, when the occupant who has produced the utterance is an occupant in a driver's seat, between the first display area and the second display area, more detailed information based on information acquired by the agent functional unit to be displayed in a display area farther from the position at which the head of the occupant who has produced the utterance is assumed to be located than in a display area closer to the position at which the head of the occupant who has produced the utterance is assumed to be located.
(12) According to another aspect of the present invention, there is provided is an agent device control method causing a computer to execute:

providing a service including causing an output unit to output a response using a sound using an agent function, in response to an utterance of an occupant in a vehicle;

causing a display provided in the vehicle to display an animation related to the agent function; and

displaying the animation in different types between a case where the animation is displayed in a first display area of the display and a case where the animation is displayed in a second display area which is different from that of the first display area.

(13) According to still another aspect of the present invention, there is provided a storage medium storing a program causing a computer to execute: a process of providing a service including causing an output unit to output a response using a sound using an agent function, in response to an utterance of an occupant in a vehicle; a process of causing a display provided in the vehicle to display an animation related to the agent function; and a process of displaying the animation in different types between a case where the animation is displayed in a first display area of the display and a case where the animation is displayed in a second display area which is different from the first display area.

According to the aspects (1) to (13), it is possible to realize in-vehicle displays in an appropriate mode when an agent provides an agent function.

### BRIEF DESCRIPTION OF THE DRAWINGS

FIG. 1 is a configuration diagram of an agent system including an agent device.

FIG. 2 is a diagram showing a configuration of an agent device according to a first embodiment and a device mounted in a vehicle.

FIG. 3 is a diagram showing an example in which a display and operation device is arranged.

FIG. 4 is a diagram showing an example in which speaker units are arranged.

FIG. 5 is a diagram explaining a principle for determining a position at which a sound image is localized.

FIG. 6 is a diagram showing an example of a driver's seat screen and a passenger's seat screen.

FIG. 7 is a diagram showing a screen example of a first display.

FIG. 8 is a diagram showing an example of an AG animation.

FIG. 9 is a diagram showing another example of an AG animation.

FIG. 10 is a diagram showing an example of a screen when an occupant in a passenger's seat produces an utterance.

FIG. 11 is a diagram showing an example of a screen when an occupant in a driver's seat produces an utterance.

FIG. 12 is a diagram showing another example of a screen when an occupant in a driver's seat produces an utterance.

FIG. 13 is a flowchart showing an example of a process performed by a display controller.

FIG. 14 is a flowchart showing another example of a process performed by the display controller.

### DESCRIPTION OF EMBODIMENTS

An agent device, an agent device control method, and a storage medium according to embodiments of the present invention will be described below with reference to the drawings. The agent device is a device that realizes some or all of an agent system. Hereinafter, an agent which is mounted in a vehicle (hereinafter referred to as a vehicle M) and has a plurality of types of agent functions will be described as an example of the agent device. The agent functions are, for example, functions of providing various types of information based on a request (command) included in an utterance of an occupant while conversation with the occupant in the vehicle M, mediating network services, and performing proposals from the agent side. A plurality of types of agents may have different functions, processing procedures, controls, output modes and contents. Some of the agent functions may have a function of controlling devices in the vehicle (for example, devices related to driving control and vehicle body control).

The agent function is realized using, for example, in addition to a voice recognition function of recognizing voice of an occupant (a function of converting voice to text), a natural language processing function (a function of understanding the structure and meaning of text), a conversation management function, a network search function of searching for other devices via a network or searching for a predetermined database stored in a host device and the like in an integrated manner Some or all of these functions may be realized by artificial intelligence (AI) technology. A part (particularly, a voice recognition function and a natural language processing interpretation function) of the configuration for performing such functions may be mounted in an agent server (external device) that can perform communication via an in-vehicle communication device in the vehicle M or a general-purpose communication device brought into the vehicle M. In the following description, it is assumed that a part of the configuration is mounted in an agent server, and an agent device and an agent server cooperate to realize an agent system. In an agent system, a service providing entity (service entity) that virtually appears in cooperation with an agent device and an agent server is referred to as an agent.

### <Overall Configuration>

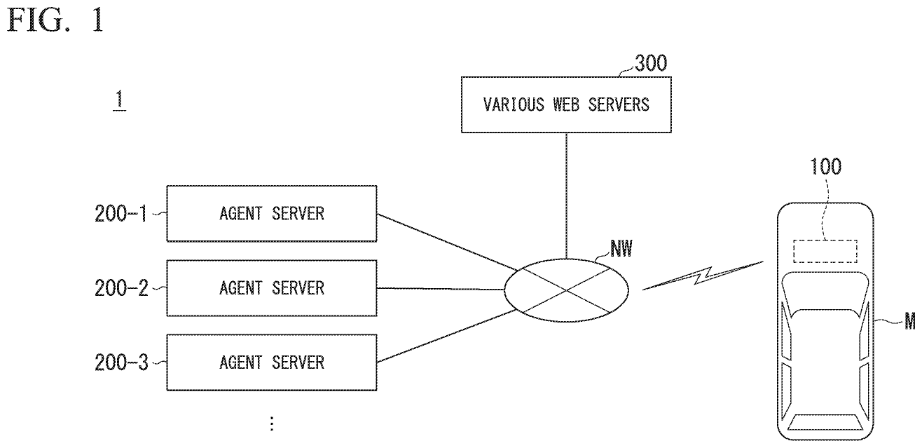

FIG. 1 is a configuration diagram of an agent system 1 including an agent device 100. The agent system 1 includes, for example, the agent device 100 and a plurality of agent servers 200-1, 200-2, and 200-3, . . . . The numbers following the hyphen at the end of the reference numerals are identifiers for distinguishing agents. If it is not necessary to distinguish between agent servers, they may be simply referred to as an agent server 200. Although three agent servers 200 are shown in FIG. 1, the number of agent servers 200 may be two, or four or more. The same agent may have a plurality of agent servers. The agent servers 200 are operated by different agent providers. Therefore, the agents in the present invention are agents realized by different providers. Examples of providers include vehicle manufacturers, network service providers, e-commerce providers, and mobile terminal sellers and manufacturers, and any entity (corporation, organization, individual, etc.,) can be an agent system provider.

The agent device 100 communicates with a plurality of types of agent servers 200 via a network NW. The network NW includes, for example, some or all of the Internet, a cellular network, a Wi-Fi network, a wide area network (WAN), a local area network (LAN), a public network, a telephone line, and a wireless base station. Various web servers 300 are connected to the network NW, and the agent server 200 or the agent device 100 can acquire web pages from the various web servers 300 via the network NW.

The agent device 100 performs conversation with an occupant in the vehicle M, transmits voice of the occupant to the agent server 200, and presents an answer obtained from the agent server 200 to the occupant in the form of a voice output or image display.

### First Embodiment

### [Vehicle]

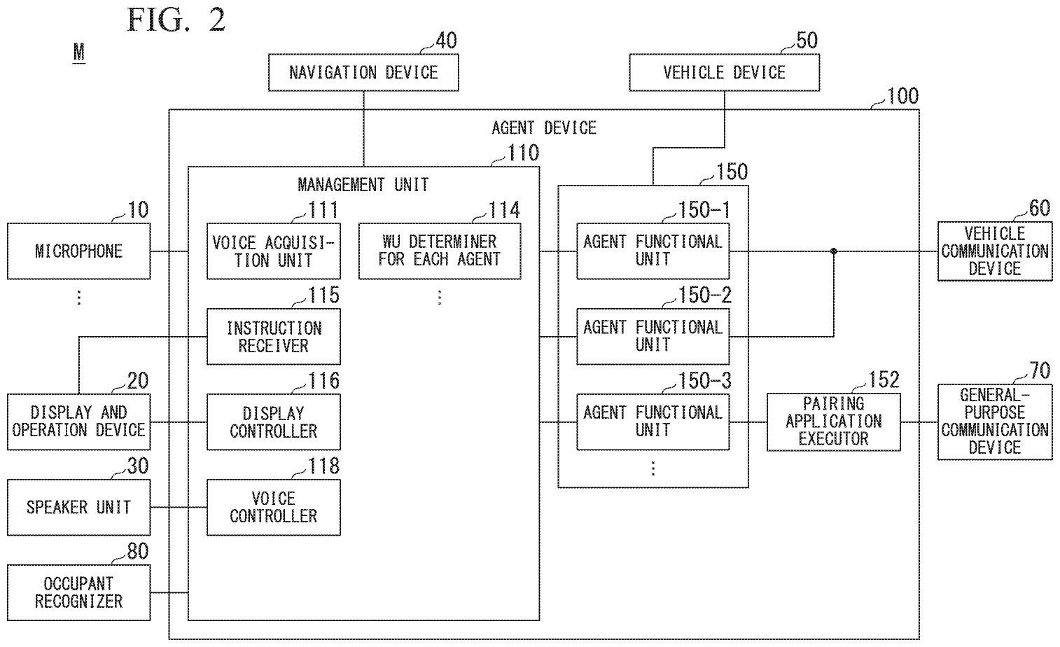

FIG. 2 is a diagram showing a configuration of the agent device 100 according to a first embodiment and devices mounted in the vehicle M. In the vehicle M, for example, one or more microphones 10, a display and operation device 20 (an example of “display”), a speaker unit 30, a navigation device 40, a vehicle device 50, an in-vehicle communication device 60, an occupant recognizer 80, and the agent device 100 are mounted. A general-purpose communication device 70 such as a smartphone may be brought into a cabin, and used as a part of a communication device or an agent system. These devices are connected to each other through a multiple communication line such as a controller area network (CAN) communication line, a serial communication line, a wireless communication network, or the like. The configuration shown in FIG. 2 is only an example, and a part of the configuration may be omitted or other components may be additionally added.

The microphone 10 is a sound collection unit that collects sounds produced in the cabin. A plurality of microphones 10 may be provided in order to acquire utterances of a plurality of occupants in the vehicle. The display and operation device 20 is a device (or a device group) that can display an image and receive an input operation. The display and operation device 20 includes, for example, a display device configured as a touch panel. The display and operation device 20 may further include a head up display (HUD), a mechanical input device, and an output device. The speaker unit 30 includes, for example, a plurality of speakers (sound output units) that are arranged at different positions in the cabin. The display and operation device 20 may be shared by the agent device 100 and the navigation device 40. Details thereof will be described below.

The navigation device 40 includes a navigation human machine interface (HMI), a positioning device such as a global positioning system (GPS), a storage device in which map information is stored, and a control device (navigation controller) that performs route searching. Some or all of the microphone 10, the display and operation device 20, and the speaker unit 30 may be used as the navigation HMI. The navigation device 40 searches for a route (navigation route) for moving from the position of the vehicle M determined by the positioning device to a destination input by the occupant, and outputs guidance information using the navigation HMI so that the vehicle M can travel along the route. A route search function may be provided in a navigation server that is accessible via the network NW. In this case, the navigation device 40 acquires the route from the navigation server and outputs guidance information. The agent device 100 may be constructed based on the navigation controller. In this case, the navigation controller and the agent device 100 are integrally formed on hardware.

The vehicle device 50 includes, for example, a driving force output device such as an engine and a driving motor, an engine starting motor, a door lock device, a door opening and closing device, windows, window opening and closing devices and window opening and closing control devices, seats, seat position control devices, room mirrors and their angular position control devices, lighting devices inside and outside the vehicle and their control devices, wipers and defoggers and their control devices, direction indicator lamps and their control devices, air conditioners, and devices for vehicle information such as travel distance and tire air pressure information and remaining fuel information.

The in-vehicle communication device 60 is a wireless communication device that can access the network NW using, for example, a cellular network or a Wi-Fi network, whether directly or indirectly. Here, “indirectly” means that the network NW is accessed via an external communication terminal such as a router.

The occupant recognizer 80 includes, for example, a seating sensor, an in-vehicle camera, a biometric authentication system, and an image recognition device. The seating sensor includes a pressure sensor provided below a seat, a tension sensor attached to a seat belt, and the like. The in-vehicle camera is a charge coupled device (CCD) camera or complementary metal oxide semiconductor (CMOS) camera provided in the cabin. The image recognition device analyzes an image of the in-vehicle camera and recognizes whether there is an occupant in each seat and a direction of the occupant's face. In the present embodiment, the occupant recognizer 80 is an example of a seating position recognizer.

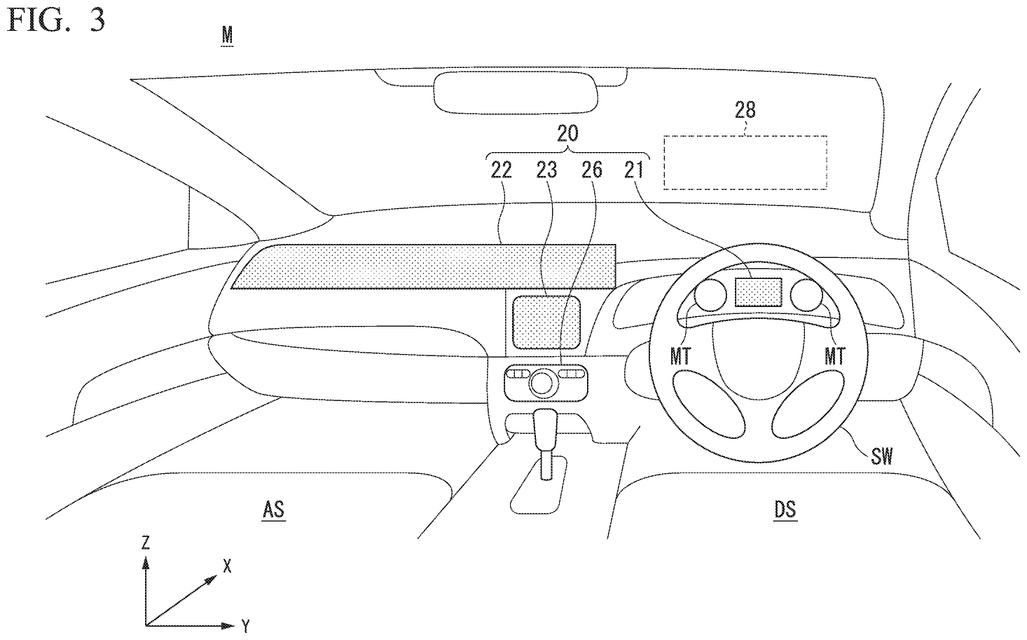

FIG. 3 is a diagram showing an example in which the display and operation device 20 is arranged. The display and operation device 20 includes, for example, a first display 21, a second display 22, a third display 23, and an operation switch ASSY 26. The display and operation device 20 may further include an HUD 28.

In the vehicle M, for example, there are a driver's seat DS in which a steering wheel SW is provided and a passenger's seat AS provided in a vehicle width direction (Y direction in the drawing) with respect to the driver's seat DS. The first display 21 is installed near a meter MT provided to face the driver's seat DS. The second display 22 is a horizontal display device that extends from near the center between the driver's seat DS and the passenger's seat AS in an instrument panel to a position facing the left end of the passenger's seat AS. The third display 23 is installed at an intermediate position between the driver's seat DS and the passenger's seat AS in the vehicle width direction and below the second display 22.

The first display 21 is an example including a first display area, and the second display 22 is an example including a second display area. Compared to the second display area, the position of the first display area in the host vehicle M is closer to a position at which the driver's head is assumed to be located. The second display 22 may have the first display area and the second display area. In this case, preferably, the second display 22 extends to the right end of the driver's seat DS.

For example, each of the first display 21, the second display 22, and the third display 23 is configured as a touch panel, and includes a liquid crystal display (LCD), organic electroluminescence (EL) display, a plasma display, or the like as a display. The operation switch ASSY 26 has a dial switch, a button switch, and the like integrated therein. The display and operation device 20 outputs content of an operation performed by the occupant to the agent device 100. Content displayed on the first display 21, the second display 22, and the third display 23 may be determined by the agent device 100.

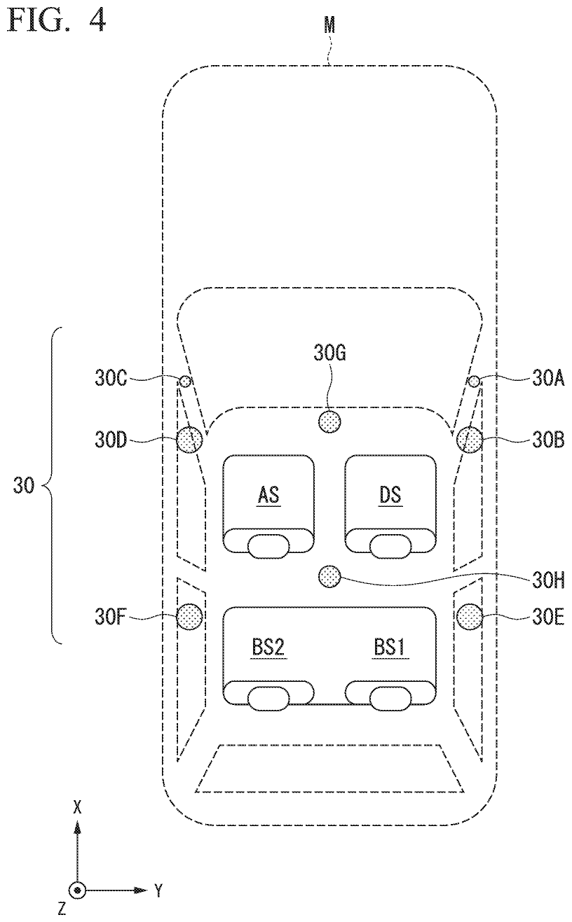

FIG. 4 is a diagram showing an example in which the speaker units 30 are arranged. The speaker unit 30 includes, for example, speakers 30A to 30H. The speaker 30A is installed on a window pillar (so-called an A pillar) on the side of the driver's seat DS. The speaker 30B is installed at a lower part of a door near the driver's seat DS. The speaker 30C is installed on a window pillar on the side of the passenger's seat AS. The speaker 30D is installed at a lower part of a door near the passenger's seat AS. The speaker 30E is installed at a lower part of a door near the side of a right rear seat BS1. The speaker 30F is installed at a lower part a door near the side of a left rear seat BS2. The speaker 30G is installed near the second display 22. The speaker 30H is installed on a ceiling (roof) of the cabin.

In such an arrangement, for example, when sound is exclusively output from the speakers 30A and 30B, a sound image is localized near the driver's seat DS. When sound is exclusively output from the speakers 30C and 30D, a sound image is localized near the passenger's seat AS. When sound is exclusively output from the speaker 30E, a sound image is localized near the right rear seat BS1. When sound is exclusively output from the speaker 30F, a sound image is localized near the left rear seat BS2. When sound is exclusively output from the speaker 30G, a sound image is localized near the front of the cabin, and when sound is exclusively output from the speaker 30H, a sound image is localized near the upper part of the cabin. The present invention is not limited thereto. When the speaker unit 30 adjusts distribution of sound output from speakers using a mixer or an amplifier, a sound image can be localized at an arbitrary position in the cabin.

### [Agent Device]

Returning to FIG. 2, the agent device 100 includes a management unit 110, agent functional units 150-1, 150-2, and 150-3, and a pairing application executor 152. The management unit 110 includes, for example, a sound processing unit 112, a wake up (WU) determiner 114 for each agent, an instruction receiver 115, a display controller 116, and a voice controller 118. When it is not necessary to distinguish between agent functional units, they will be simply referred to as an agent functional unit 150. The illustration of three agent functional units 150 is only an example corresponding to the number of agent servers 200 in FIG. 1, and the number of agent functional units 150 may be two or four or more. A software arrangement shown in FIG. 2 is simply illustrated for explanation, and actually, for example, the management unit 110 may be interposed between the agent functional unit 150 and the in-vehicle communication device 60, and the arrangement can be arbitrarily modified.

Each component of the agent device 100 is realized by, for example, executing a program (software) by a hardware processor such as a central processing unit (CPU). Some or all of these components may be realized by hardware (circuit unit; including a circuitry) such as a large scale integration (LSI), an application specific integrated circuit (ASIC), a field-programmable gate array (FPGA), and a graphics processing unit (GPU), or realized by software and hardware in cooperation. The program may be stored in advance in a storage device (a storage device including a non-transitory storage medium) such as a hard disk drive (HDD) and a flash memory, or stored in a removable storage medium (non-transitory storage medium) such as a DVD and a CD-ROM, and the program may be installed by mounting the storage medium in a drive device.

The management unit 110 functions when a program such as an operating system (OS) or middleware is executed.

The sound processing unit 112 of the management unit 110 performs sound processing on the input sound so that the state is suitable for recognizing a wake-up word set in advance for each agent.

The WU determiner 114 for each agent is provided in correspondence with each of the agent functional units 150-1, 150-2, and 150-3, and recognizes a wake-up word predetermined for each agent. The WU determiner 114 for each agent recognizes the meaning of voice from the voice (voice stream) subjected to the sound processing. First, the WU determiner 114 for each agent detects a voice section based on the amplitude and zero crossing of the voice waveform in the voice stream. The WU determiner 114 for each agent may perform section detection based on voice identification and non-voice identification in units of frames based on a Gaussian mixture model (GMM).

Next, the WU determiner 114 for each agent determines whether the voice in the detected voice section corresponds to a wake-up word. When the voice is determined as a wake-up word, the WU determiner 114 for each agent activates the corresponding agent functional unit 150 and activates the agent. A function corresponding to the WU determiner 114 for each agent may be mounted in the agent server 200. In this case, the management unit 110 transmits a voice stream on which the sound processing is performed by the sound processing unit 112 to the agent server 200, and when the agent server 200 determines that the voice is a wake-up word, the agent functional unit 150 is activated according to the instruction from the agent server 200. Each of the agent functional units 150 may be activated always and may determine the wake-up word by itself. In this case, the management unit 110 does not need to include the WU determiner 114 for each agent.

The agent functional unit 150 causes the agent to appear in cooperation with the corresponding agent server 200 and provides an agent function including a voice response according to the utterance of the occupant in the vehicle. The agent functional unit 150 may include one to which authority to control the vehicle device 50 is given. Some of the agent functional units 150 may communicate with the agent server 200 in cooperation with the general-purpose communication device 70 through the pairing application executor 152. For example, authority to control the vehicle device 50 is given to the agent functional unit 150-1. The agent functional unit 150-1 communicates with the agent server 200-1 via the in-vehicle communication device 60. The agent functional unit 150-2 communicates with the agent server 200-2 via the in-vehicle communication device 60. The agent functional unit 150-3 communicates with the agent server 200-3 in cooperation with the general-purpose communication device 70 via the pairing application executor 152. The pairing application executor 152 performs pairing with the general-purpose communication device 70 using, for example, Bluetooth (registered trademark), and connects the agent functional unit 150-3 and the general-purpose communication device 70. The agent functional unit 150-3 may be connected to the general-purpose communication device 70 via wired communication using a universal serial bus (USB) or the like. Hereinafter, an agent that causes the agent functional unit 150-1 and the agent server 200-1 to appear in cooperation with each other may be referred to as an agent 1, an agent that causes the agent functional unit 150-2 and the agent server 200-2 to appear in cooperation with each other may be referred to as an agent 2, and an agent that causes the agent functional unit 150-3 and the agent server 200-3 to appear in cooperation with each other may be referred to as an agent 3.

The instruction receiver 115 receives an instruction from the occupant using the display and operation device 20. The present invention is not limited thereto, and the instruction receiver 115 may have a voice recognition function, and receive an instruction from the occupant by recognizing the meaning of voice based on in-vehicle voice. The in-vehicle voice includes a sound input from the microphone 10, voice (voice stream) subjected to sound processing by the sound processing unit 112, and the like.

The display controller 116 causes the first display 21, the second display 22 or the third display 23 to display an image or a video according to an instruction from the agent functional unit 150.

In the following, the display controller 116 generates an image for the driver's seat screen and an image for the passenger's seat screen according to the instruction from the agent functional unit 150, and causes the first display 21 to display the image for the driver's seat screen and causes the second display 22 to display the image for the passenger's seat screen. The image for the driver's seat screen and the image for the passenger's seat screen will be described below. The display controller 116 generates, as a part of the image for the passenger's seat and the image for the driver's seat, for example, an anthropomorphic agent animation (hereinafter referred to as an AG animation) that communicates with the occupant in the cabin, and causes the first display 21 and the second display 22 to display the generated AG animation.

The AG animation is, for example, an animation representing an agent character, an agent icon, and the like. The AG animation is, for example, an image or a video in a mode in which a human or an anthropomorphic object speaks to the occupant. The AG animation may include, for example, a face image in which at least a facial expression and face direction are recognized by the viewer (occupant). For example, in the AG animation, parts simulating eyes and a nose are shown in the face area, and the facial expression and face direction may be recognized based on the positions of the parts in the face area. The AG animation is perceived three-dimensionally, and the viewer may recognize a face direction of the agent when a head image in a three-dimensional space is included, and may recognize an action (an operation and a behavior), a posture, and the like of the agent when a body (torso and limbs) image is included.

For example, when the agent functional unit 150 is activated, the display controller 116 causes the first display 21, the second display 22, and the like to display an AG animation. The display controller 116 may change the action of the AG animation according to the utterance of the occupant. For example, the display controller 116 may cause the AG animation to execute a small action while the agent is waiting, and when the agent executes a process corresponding to the utterance of the occupant, the display controller 116 may cause the AG animation to execute an action corresponding to the process to be executed.

The voice controller 118 causes some or all of speakers included in the speaker unit 30 to output voice according to the instruction from the agent functional unit 150. The voice controller 118 may perform control using the plurality of speaker units 30 so that a sound image of an agent voice is localized at a position corresponding to the display position of the AG animation. The position corresponding to the display position of the AG animation is, for example, a position at which the occupant is expected to perceive that the AG animation is speaking an agent voice, specifically, a position near the display position (for example, within 2 to 3 [cm]) of the AG animation. Localization of a sound image is determination of a spatial position of a sound source that the occupant feels, for example, by adjusting the loudness and timing of sound transmitted to left and right ears of the occupant.

### [Agent Server]

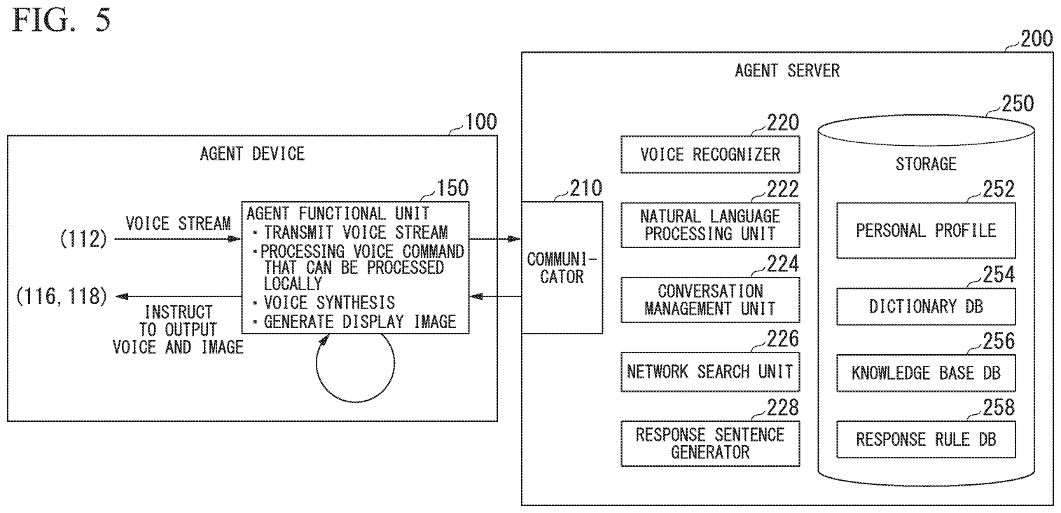

FIG. 5 is a diagram showing a configuration of the agent server 200 and a part of a configuration of the agent device 100. Hereinafter, the configuration of the agent server 200 and operations of the agent functional unit 150 and the like will be described. Here, physical communication from the agent device 100 to the network NW will not be described.

The agent server 200 includes a communicator 210. The communicator 210 is, for example, a network interface such as a network interface card (NIC). The agent server 200 further includes, for example, a voice recognizer 220, a natural language processing unit 222, a conversation management unit 224, a network search unit 226, and a response sentence generator 228. For example, these components are realized when a hardware processor such as a CPU executes a program (software). Some or all of these components may be realized by hardware (circuit unit; including a circuitry) such as an LSI, an ASIC, an FPGA, and a GPU, or realized by software and hardware in cooperation. The program may be stored in advance in a storage device (a storage device including a non-transitory storage medium) such as an HDD and a flash memory, or stored in a removable storage medium (non-transitory storage medium) such as a DVD and a CD-ROM, and the program may be installed by mounting the storage medium in a drive device.

The agent server 200 includes a storage 250. The storage 250 is realized by the above various storage devices. In the storage 250, data and programs such as a personal profile 252, a dictionary database (DB) 254, a knowledge base DB 256, and a response rule DB 258 are stored.

In the agent device 100, the agent functional unit 150 transmits the voice stream or the voice stream on which processing such as compression or encoding has been performed to the agent server 200. When a voice command that can be processed locally (processed without the intervention of the agent server 200) is recognized, the agent functional unit 150 may perform a process requested by the voice command. The voice command that can be processed locally may be a voice command that can be answered with reference to a storage (not shown) included in the agent device 100 or a voice command (for example, a command to turn an air conditioner on) for controlling the vehicle device 50 in the case of the agent functional unit 150-1. Therefore, the agent functional unit 150 may have some of functions that the agent server 200 has.

When the voice stream is acquired, the voice recognizer 220 performs voice recognition and outputs text information by converting it into text, and the natural language processing unit 222 performs semantic interpretation on the text information with reference to the dictionary DB 254. In the dictionary DB 254, abstract meaning information is associated with text information. The dictionary DB 254 may include synonym and poecilonym list information. The processing of the voice recognizer 220 and the processing of the natural language processing unit 222 are not clearly divided into stages, but they affect each other, for example, the voice recognizer 220 that has received the processing result of the natural language processing unit 222 correcting the recognition result.

For example, when the meaning such as “today's weather” or “how is the weather” is recognized as the recognition result, the natural language processing unit 222 generates a command replaced with standard text information “today's weather.” Accordingly, even if there is a character fluctuation in voice of a request, it is possible to easily perform conversation according to the request. For example, the natural language processing unit 222 may recognize the meaning of text information using artificial intelligence processing such as machine learning processing using a probability and generate a command based on the recognition result.

The conversation management unit 224 determines the content of the utterance for the occupant in the vehicle M with reference to the personal profile 252, the knowledge base DB 256, and the response rule DB 258 based on the processing result (command) of the natural language processing unit 222. The personal profile 252 includes occupant personal information, hobbies and preferences, a past conversation history, and the like which are stored for each occupant. The knowledge base DB 256 is information that defines the relationship between objects. The response rule DB 258 is information that defines operations (such as an answer and details of device control) that the agent should perform according to commands.

The conversation management unit 224 may determine the occupant by performing comparison with the personal profile 252 using feature information obtained from the voice stream. In this case, in the personal profile 252, for example, personal information is associated with voice feature information. The voice feature information is, for example, information about characteristics of speaking styles such as voice pitch, intonation, and rhythm (sound pitch pattern) and features such as Mel frequency cepstrum coefficients. The voice feature information is, for example, information obtained by having the occupant utter a predetermined word or sentence or the like when the occupant is initially registered, and recognizing the voice of the utterance.

When the command requests information that can be searched for via the network NW, the conversation management unit 224 causes the network search unit 226 to perform searching. The network search unit 226 accesses the various web servers 300 via the network NW and acquires desired information. “Information that can be searched for via the network NW” is, for example, results of restaurants near the vehicle M evaluated by general users, or a weather forecast of that day according to the position of the vehicle M.

The response sentence generator 228 generates a response sentence so that the content of the utterance determined by the conversation management unit 224 is transmitted to the occupant of the vehicle M and transmits the sentence to the agent device 100. When the occupant is determined as an occupant registered in the personal profile, the response sentence generator 228 may call the name of the occupant or generate a response sentence in a speaking style similar to that of the occupant.

When the response sentence is acquired, the agent functional unit 150 instructs the voice controller 118 to perform voice synthesis and output voice. The agent functional unit 150 instructs the display controller 116 to display the AG animation according to the voice output. In this manner, an agent function in which the virtually appearing agent responds to the occupant in the vehicle M is realized.

### [Display Control]

The display controller 116 causes the first display 21 and the second display 22 to display information about services, agents and the like provided by the agent functional unit 150, and display the AG animation in different types between display on the first display 21 and display on the second display 22. For example, the display controller 116 causes the first display 21 to display the AG animation in a simpler mode compared to when the AG animation is displayed on the second display 22. The simple mode is a display type that does not draw attention of the viewer (occupant).

The simple mode includes, for example, reducing, slowing, minimizing (compressing), and simplifying the motion of the AG animation. The simple mode includes, for example, regarding the color of the AG animation, weakening the contrast, reducing the number of colors used, and weakening (darkening) the color. The present invention is not limited thereto, and the simple mode may include, for example, reducing the size of the AG animation, minimizing the facial expressions of the AG animation, displaying only the face without displaying the body (torso and limbs) of the AG animation, not displaying any tools together with the AG animation, and not changing the color of the AG animation midway.

In other words, the display controller 116 causes the second display 22 to display the AG animation in a richer mode compared to when the AG animation is displayed on the first display 21. The rich mode is a display type that draws the attention of the viewer (occupant). The rich mode is opposite to the simple mode described above, and includes, for example, regarding the motion of the AG animation, increasing the motion, making the motion faster, making the motion larger (dynamic), and making the motion more expressive. The rich mode includes, regarding the color of the AG animation, increasing the contrast, increasing the number of colors used, and making the color light (bright). The present invention is not limited thereto, and the rich mode includes, for example, increasing the size of the AG animation, making the facial expression of the AG animation rich, displaying the body (torso and limbs) of the AG animation, displaying some tools together with the AG animation, and changing the color of the AG animation when the correspondence of the agent functional unit 150 is changed according to the utterance of the occupant.

When the display controller 116 causes the first display 21 to display the AG animation according to the utterance of the occupant, the AG animation may be displayed in a simpler mode compared to when the AG animation is displayed on the second display 22. For example, when the AG animation is caused to execute a predetermined action (an operation and a behavior) according to the utterance of the occupant, the display controller 116 causes the AG animation to be displayed on the second display 22 to execute an action according to the utterance of the occupant, and does not cause the AG animation to be displayed on the first display 21 to execute an action according to the utterance of the occupant. The present invention is not limited thereto, and when the utterance of the occupant includes predetermined content such as a wake-up word or a “simple mode,” the display controller 116 causes the first display 21 to display the AG animation in a simpler mode compared to when the AG animation is displayed on the second display 22.

The display controller 116 may cause agent information provided in response to the utterance of the occupant to display the display and operation device 20. The agent information includes, for example, a recommendation list recommended by the agent for the occupant, and search results found using a search engine based on conditions requested by the occupant.

The display controller 116 may vary the display type of agent information between display of agent information on the first display 21 and display of agent information on the second display 22. For example, the display controller 116 reduces the amount of information displayed on the display when agent information is displayed on the first display 21 compared to when agent information is displayed on the second display 22. The present invention is not limited thereto, and the display controller 116 may cause the first display 21 to display agent information in a simpler mode compared to when agent information is displayed on the second display 22.

When actions with the same meaning according to the agent functional unit 150 are caused to be displayed on the AG animation, the display controller 116 may cause the first display 21 and the second display 22 to display at the same timing or cause the first display 21 and the second display 22 to display at different timings. The display controller 116 may cause the first display 21 and the second display 22 to display a part of the same agent information acquired by the agent functional unit 150 at the same timing or cause the first display 21 and the second display 22 to display it at different timings.

### [Screen Example Part 1]

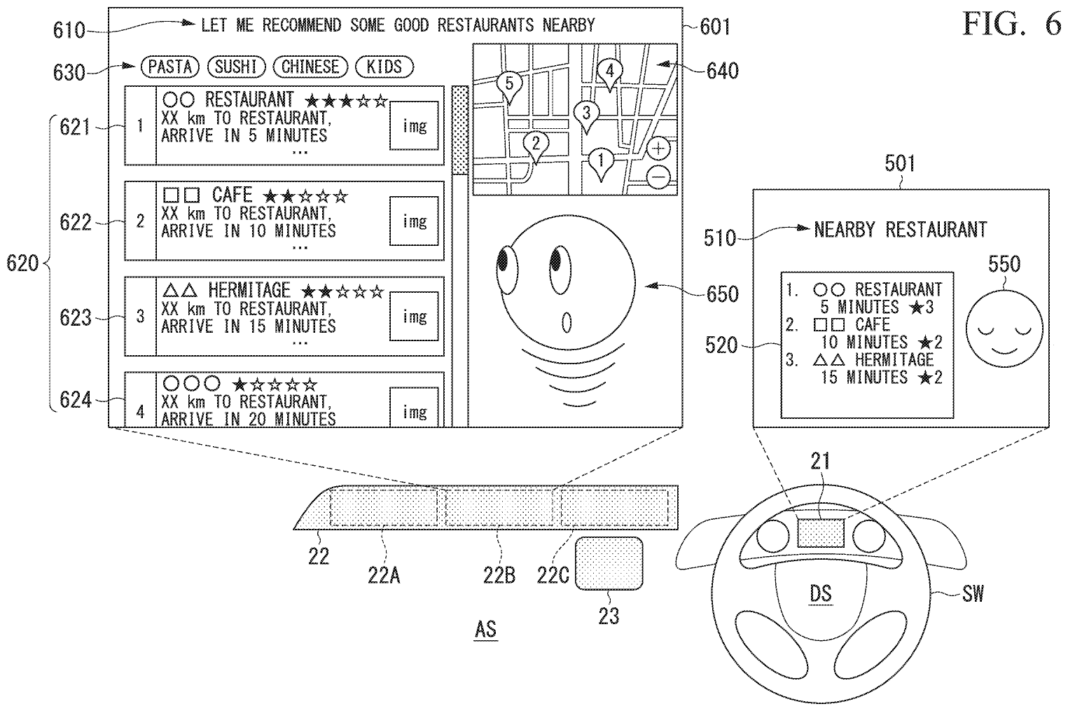

FIG. 6 is a diagram showing an example of a driver's seat screen and a passenger's seat screen. A driver's seat screen 501 includes a service title 510, a recommendation list 520, and an AG animation 550. A passenger's seat screen 601 includes a service title 610, a recommendation list 620, a limiting condition 630, surrounding map 640, and an AG animation 650. Here, an example in which the agent functional unit 150-1 accesses the various web servers 300 via the network NW in cooperation with the agent server 200-1, acquires recommendation information according to a request from the occupant, and provides a recommended service in which the acquired recommendation information is provided to the occupant is provided is described. When one of the recommendation information is selected as a destination by the occupant, the agent functional unit 150-1 may control the vehicle device 50 so that the host vehicle M is caused to travel toward the selected destination.

The service titles 510 and 610 represent the outline of services provided by the agent functional unit 150-1. The recommendation lists 520 and 620 represent a part of recommendation information acquired by the agent functional unit 150-1. The recommendation lists 520 and 620 include, for example, information about restaurants around the host vehicle M. The recommendation list 620 includes a plurality of recommendation elements 621, 622, 623, and 624 . . . , and information about each restaurant is summarized for each recommendation element.

The limiting condition 630 indicates a condition that narrows down (restricts) information to be displayed on the recommendation list 620. The surrounding map 640 indicates the position of each restaurant included in the recommendation list 520. The AG animations 550 and 650 are agent animations corresponding to the agent functional unit 150-1. Here, the agent corresponding to the agent functional unit 150-1 is, for example, an animation that looks like an anthropomorphic round ball and provides a similar impression to a viewer. This allows the occupant to recognize that agents are for the same agent functional unit 150-1 although expression modes are different.

Less text is displayed in the service title 510 than the service title 610. The service title 510 expresses a service provided by the agent in one word, and the service title 610 expresses a service provided by the agent in a polite sentence. Accordingly, the occupant in the driver's seat DS can estimate the content of displayed information in a short time, and it is possible to prevent the occupant in the driver's seat DS from concentrating on the display.

The recommendation list 520 has less text displayed and a smaller amount of information than the recommendation list 620. In the recommendation list 520, for example, the name of the restaurant, the time required to reach the restaurant, and an evaluation of the restaurant are displayed. In addition to the name of the restaurant, the time required to reach the restaurant, and an evaluation of the restaurant, the recommendation list 620 may include, for example, the distance to the restaurant, the business hours of the restaurant, reviews of the restaurant, the price range, and image pictures. Not only are the numbers of display items different, but information displayed on the recommendation lists 520 and 620 may also be displayed differently. For example, the evaluation of the restaurant is expressed as the number of stars in a star illustration in the recommendation list 620 and expressed as a number that is the number of stars in the recommendation list 520. Accordingly, the occupant in the driver's seat DS can obtain simple information about the nearby restaurant. It is possible to prevent the occupant in the driver's seat DS from concentrating on the display in order to view a large amount of information displayed.

The AG animation 550 is displayed in a simpler mode than the AG animation 650. For example, the AG animation 550 does not move and a facial expression also does not change. On the other hand, the AG animation 650 continues to move up and down, and the gaze direction and the position and shape of the mouth change. The AG animation 550 has a smaller size, a gentler facial expression, and a simpler color than the AG animation 650. Accordingly, it is possible to prevent the occupant in the driver's seat DS from concentrating on the AG animation 550 and from watching the change in the AG animation 550.

The display controller 116 causes the limiting condition 630 and the surrounding map 640 to be displayed only on the second display 22, and causes them not to be displayed on the first display 21, and thus the display type may be changed. When the limiting condition 630 is displayed on the second display 22, the instruction receiver 115 receives a condition limitation instruction from the occupant in the passenger's seat AS, and it is possible to further narrow down information displayed on the recommendation list 620. The occupant in the passenger's seat AS can operate the limiting condition 630 according to his or her own determination or the instruction of the occupant in the driver's seat DS. When the display controller 116 causes the limiting condition 630 not to be displayed on the first display 21, it is possible to prevent the occupant in the driver's seat DS from manually inputting an instruction to the agent. When the surrounding map 640 is displayed on only the second display 22, it is possible to prevent the occupant in the driver's seat DS from concentrating on a fine map. The condition limitation instruction is not limited to being received by the second display 22, and it may be received by the instruction receiver 115 using a voice recognition function. In this case, the occupant in the passenger's seat AS can see and confirm the limiting condition 630, and instruct limitation of the condition, thereby improving convenience.

The display controller 116 may cause the AG animation to execute an action according to the utterance of the occupant. Examples of actions include motions, behaviors, and facial expressions. For example, when waiting for the occupant to speak, the AG animation may perform an action in which it awaits quietly. When information according to the utterance of the occupant is searched for, the AG animation may perform an action in which it looks for something without a magnifying glass.

### [Screen Example Part 2]

When a part of agent information displayed on the second display 22 is designated by the occupant in the passenger's seat AS using the display and operation device 20, the display controller 116 may change the display of the first display 21 to information based on a part of the agent information designated by the occupant in the passenger's seat AS. The designation of a part of the agent information may be received using a voice recognition function by the instruction receiver 115.

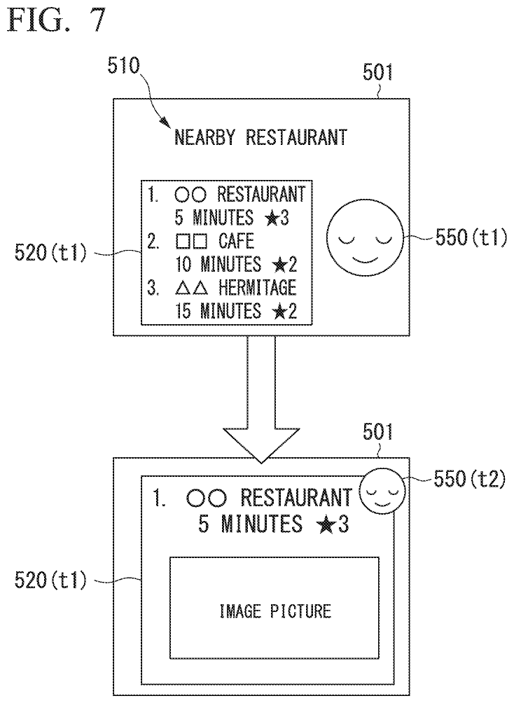

FIG. 7 is a diagram showing a screen example of the first display 21. The recommendation list 520 (t1) and the AG animation 550 (t1) have the same display types shown in FIG. 6. For example, in the display controller 116, when the recommendation element 621 (refer to FIG. 6) displayed on the second display 22 is touched by the occupant in the passenger's seat AS, the instruction receiver 115 is notified that the recommendation element 621 has been designated, and notifies the display controller 116 of that fact. The display controller 116 causes the first display 21 to display information related to the restaurant corresponding to the recommendation element 621. For example, the display controller 116 causes the first display 21 to display the recommendation list 520 (t2) and the AG animation 550 (t2) as shown in FIG. 7.

The recommendation list 520 (t2) includes, regarding the restaurant corresponding to the recommendation element 621, the name of the restaurant, the time required to reach the restaurant, an evaluation of the restaurant, and image pictures. That is, when one recommendation element displayed on the second display 22 is selected by the occupant, the display controller 116 reduces the number of recommendation elements displayed on the recommendation list 520. Therefore, the display controller 116 can make the size of text displayed on the recommendation list 520 (t2) larger than that of the recommendation list 520 (t1), and cause an image picture that is not displayed on the recommendation list 520 (t1) to be displayed on the recommendation list 520 (t2). Accordingly, the occupant in the driver's seat DS can easily see information about the restaurant selected by the occupant in the passenger's seat AS, and compared to a screen that is difficult to view because much small text is displayed, it is possible to prevent the occupant in the driver's seat DS from concentrating on the display. The occupant in the passenger's seat AS can ask the occupant in the driver's seat DS about visiting the restaurant in which he or she is interested.

When one recommendation element displayed on the second display 22 is selected by the occupant, the display controller 116 may make the AG animation 550 (t2) smaller than the AG animation 550 (t1), and change the display position to the edge of the screen.

### [Screen Example Part 3]

When the AG animation is caused to execute an action according to the utterance of the occupant, the display controller 116 may make the action of the AG animation displayed on the first display 21 different from the action of the AG animation displayed on the second display 22. For example, the display controller 116 displays the action of the AG animation on the first display 21 in a simpler mode than the action of the AG animation displayed on the second display 22. Here, the simple mode includes, for example, gentle facial expressions, quiet motions, calm behaviors, and expressions from which a viewer receives a weak stimulus.

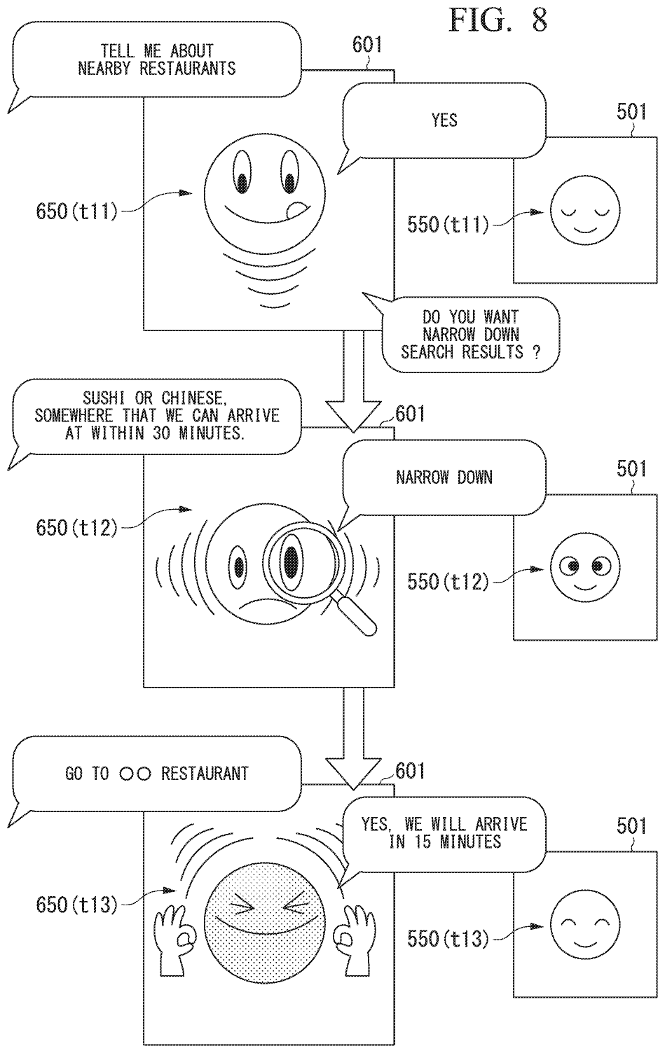

FIG. 8 is a diagram showing an example of an AG animation. For example, it is assumed that the occupant has uttered “Tell me about nearby restaurants.” According to the utterance, the agent functional unit 150-1 acquires information about restaurants around the host vehicle M from the various web servers 300 in cooperation with the agent server 200-1. Then, the display controller 116 causes the first display 21 and the second display 22 to display the recommendation lists 520 and 620 shown in FIG. 6 and the AG animation 550 (t11) and 650 (t11) shown in FIG. 8, respectively. Then, the voice controller 118 causes the plurality of speaker units 30 to output an agent voice of “Yes” “Do you want narrow down the search results?”.

The AG animation 550 (t11) is a quiet animation with closed eyes without any movement. The AG animation 650 (t11) is an animation in which the tongue is slightly out to express hunger, and moves up and down.

Next, it is assumed that the occupant has uttered “sushi or Chinese” “Somewhere that we can arrive at within 30 minutes.” In response to the utterance, the agent functional unit 150-1 extracts information about restaurants that can be arrived at within 30 minutes from the position of the host vehicle M, which are “sushi or Chinese” genre restaurants, from information acquired from the various web servers 300. Then, the display controller 116 changes the recommendation lists 520 and 620 based on the extracted information, and causes the AG animations 550 (t12) and 650 (t12) to display the first display 21 and the second display 22, respectively. Then, the voice controller 118 causes the plurality of speaker units 30 to output an agent voice of “narrowed down.”

The AG animation 550 (t12) is a simple animation with opened eyes without any movement. The AG animation 650 (t12) is an animation of holding up a magnifying glass and looking for something and moves left and right.

Next, it is assumed that the occupant has uttered “Go to OO restaurant.” In response to the utterance, the agent functional unit 150-1 controls the vehicle device 50 such that the host vehicle M is caused to travel toward the address of “OO restaurant.” Then, the display controller 116 causes the first display 21 and the second display 22 to display the AG animations 550 (t13) and 650 (t13), respectively. Then, the voice controller 118 causes the plurality of speaker units 30 to output “Yes” “We will arrive within 15 minutes” in an agent voice.

The AG animation 550 (t13) is a simple smile animation without any movement. The AG animation 650 (t13) is an animation which has a happy facial expression and expresses an Ok sign with fingers, and of which size changes, becoming larger or smaller. The AG animation 650 (t13) is represented by a color different from that of the AG animation 650 (t11).

In this manner, when the action of the AG animation is changed, it is possible to prevent the occupant in the driver's seat DS from concentrating on the display, and it is possible to entertain the occupant in the passenger's seat AS.

### [Screen Example Part 4]

The display controller 116 may change at least one of the display position and the display type of the AG animation according to the driving situation of the host vehicle M. For example, when the driving situation of the host vehicle M satisfies a predetermined condition, the display controller 116 changes at least one of the display position and the display type of the AG animation. The predetermined condition includes, for example, turning a curve, traveling at a speed of a threshold value or more, traveling on a highway, traveling in a residential area, changing lanes, overtaking a preceding vehicle, or changing a destination.

For example, when the driving situation of the host vehicle M satisfies a predetermined condition, the display controller 116 moves the display position of the AG animation toward the outer edge of the screen. The present invention is not limited thereto, and when the driving situation of the host vehicle M satisfies a predetermined condition, the display controller 116 may move the AG animation for the driver's seat to the passenger's seat screen. When the driving situation of the host vehicle M satisfies a predetermined condition, the display controller 116 may display the AG animation in a simpler mode compared to when the driving situation of the host vehicle M does not satisfy a predetermined condition.

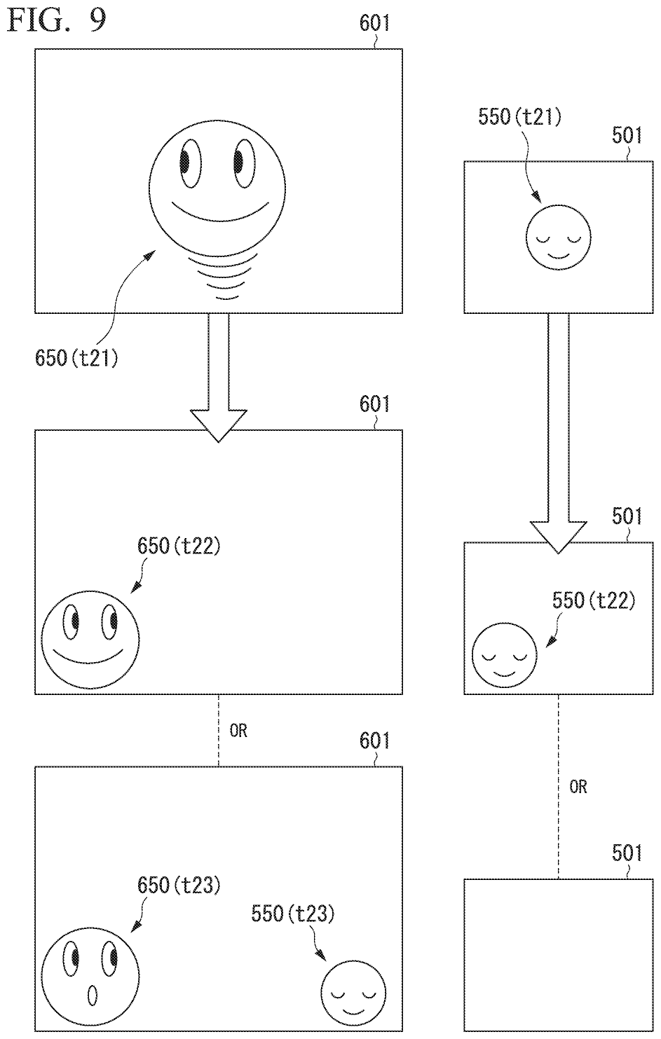

FIG. 9 is a diagram showing another example of an AG animation. Here, display of only an AG animation will be described and other display contents will not be described. The AG animation 550 (t21) is displayed at the center of the driver's seat screen 501, and the AG animation 650 (t21) is displayed at the center of the passenger's seat screen 601. The AG animation 550 (t21) is a quiet animation with closed eyes and having no movement. The AG animation 650 (t21) is an animation with opened eyes and with a gaze directed to the side opposite to the driver's seat DS, which moves up and down.

Here, when the driving situation of the host vehicle M satisfies a predetermined condition, the display controller 116 causes the driver's seat screen 501 to display the AG animation 550 (t22), and causes the passenger's seat screen 601 to display the AG animation 650 (t22). The AG animation 550 (t22) is displayed at the left corner of the driver's seat screen 501, and the AG animation 650 (t22) is displayed at the left corner of the passenger's seat screen 601. That is, when the driving situation of the host vehicle M satisfies a predetermined condition, the AG animation moves toward the edge of the screen.

The AG animation 550 (t22) is the same animation as the AG animation 550 (t21). The AG animation 650 (t22) has a gaze that is changed to the side of the driver's seat DS and has no movement. The AG animation 650 (t22) has a smaller size than the AG animation 650 (t21). That is, when the driving situation of the host vehicle M satisfies a predetermined condition, the display type of the AG animation is changed to a simple mode.

When the driving situation of the host vehicle M satisfies a predetermined condition, the display controller 116 may cause the AG animation 550 (t23) and the AG animation 650 (t23) to be displayed on the passenger's seat screen 601. The AG animation 550 (t23) is displayed at the right corner of the passenger's seat screen 601, and the AG animation 650 (t23) is displayed at the left corner of the passenger's seat screen 601. That is, when the driving situation of the host vehicle M satisfies a predetermined condition, the AG animation 550 (t23) moves from the driver's seat screen 501 to the passenger's seat screen 601.

The AG animation 550 (t23) is the same animation as the AG animation 550 (t21). The AG animation 650 (t23) has a gaze that is changed to the side of the driver's seat DS, and has a surprise facial expression, and has no movement. The AG animation 650 (t23) has a smaller size than the AG animation 650 (t21).

Accordingly, when the driving situation of the host vehicle M satisfies a predetermined condition, it is possible to prevent the occupant in the driver's seat DS from being distracted by the AG animation 550 displayed on the driver's seat screen 501. When the occupant in the passenger's seat AS has noticed of the change in the AG animation 650, it is recognized that the driving situation satisfies a predetermined condition, and it is possible to restrict an action such as speaking to the occupant in the driver's seat DS. Therefore, it is possible to create an environment in which the occupant in the driver's seat DS concentrates on driving.

### [Screen Example Part 5]

The display controller 116 may cause any display that is closer to the position at which the occupant's head is assumed to be located between the first display 21 and the second display 22 to display the AG animation based on the position of the seat of the occupant who has produced the utterance in the host vehicle M. The display closer to the position at which the head of the occupant in the driver's seat DS is assumed to be located is, for example, the first display 21, and the display closer to the position at which the head of the occupant in the passenger's seat AS is assumed to be located is, for example, the second display 22.

Regarding the position of the seat of the occupant who has produced the utterance in the host vehicle M, for example, based on the output of the microphone 10, the agent functional unit 150 determines a direction in which the voice is produced, and determines a seat on which the occupant who has produced the utterance is predicted to be sitting. The present invention is not limited thereto, and the agent functional unit 150 may detect “occupant whose mouth is moving” from the image based on the output of the occupant recognizer 80, and determine the position of the seat of the detected occupant as a position of the seat of the occupant who has produced the utterance in the host vehicle M.

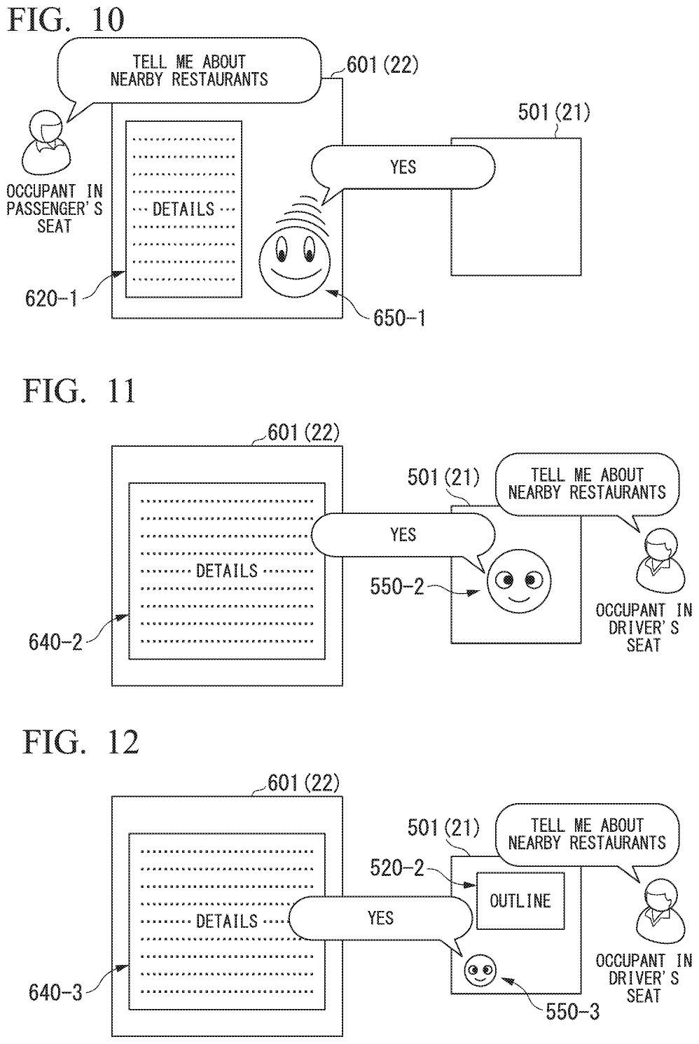

FIG. 10 is a diagram showing an example of a screen when an occupant in a passenger's seat produces an utterance. When the occupant in the passenger's seat AS uttered “Tell me about nearby restaurants,” the display controller 116 causes the second display 22 to display the recommendation list 620-1 and the AG animation 650-1. In the recommendation list 620-1, details of recommendation information as shown in FIG. 6 are displayed. On the other hand, the display controller 116 causes the first display 21 not to display the recommendation list and the AG animation.

Accordingly, when the agent provides a service in response to the request from the occupant in the passenger's seat AS, the content of agent information and the fact that the agent is activated can be kept secret from the occupant in the driver's seat DS. It is possible to prevent information and the agent that the driver did not request from being displayed on the driver's seat screen 501, and it is possible to create an environment in which the occupant in the driver's seat DS concentrates on driving.

### [Screen Example Part 6]

When the occupant who has produced the utterance is an occupant in the driver's seat DS, the display controller 116 may cause, between the first display 21 and the second display 22, the second display 22 farther from the position at which the head of the occupant who has produced the utterance is assumed to be located to display more detailed information based on agent information acquired by the agent functional unit, compared to the first display 21 closer to the position at which the head of the occupant who has produced the utterance is assumed to be located.

FIG. 11 is a diagram showing an example of a screen when an occupant in a driver's seat produces an utterance. When the occupant in the driver's seat DS utters “Tell me about nearby restaurants,” the display controller 116 causes the first display 21 to display the AG animation 550-2 and the second display 22 to display the recommendation list 620-2. The AG animation 550-2 has a simpler display type than the AG animation 650-1 shown in FIG. 10. In the recommendation list 620-2, details of recommendation information as shown in FIG. 6 are displayed.

Accordingly, when the agent provides a service in response to the request from the occupant in the driver's seat DS, the AG animation 550-2 is displayed on the first display 21 to inform the occupant in the driver's seat DS that the agent is providing a service, and it is possible to provide details of information acquired by the agent to the occupant in the passenger's seat AS.

When the occupant who has produced the utterance is an occupant in the driver's seat DS, the display controller 116 may cause the first display 21 closer to the position at which the head of the occupant who has produced the utterance is assumed to be located to display the outline based on agent information, and cause the second display 22 farther from the position at which the head of the occupant who has produced the utterance is assumed to be located to display more detailed information based on agent information.

FIG. 12 is a diagram showing another example of a screen when an occupant in a driver's seat produces an utterance. When the occupant in the driver's seat DS uttered “Tell me about nearby restaurants,” the display controller 116 causes the first display 21 to display the recommendation list 520-3 and the AG animation 550-3, and causes the second display 22 to display the recommendation list 620-3. The AG animation 550-2 has a simpler display type than the AG animation 650-1 shown in FIG. 10 and the AG animation 650-2 shown in FIG. 11. In the recommendation list 620-3, details of recommendation information as shown in FIG. 6 are displayed. The recommendation list 520-3 has a smaller amount of information than the recommendation list 620-3. Accordingly, a part of the recommendation information acquired by the agent can be provided to the occupant in the driver's seat DS.

### [Flowchart]

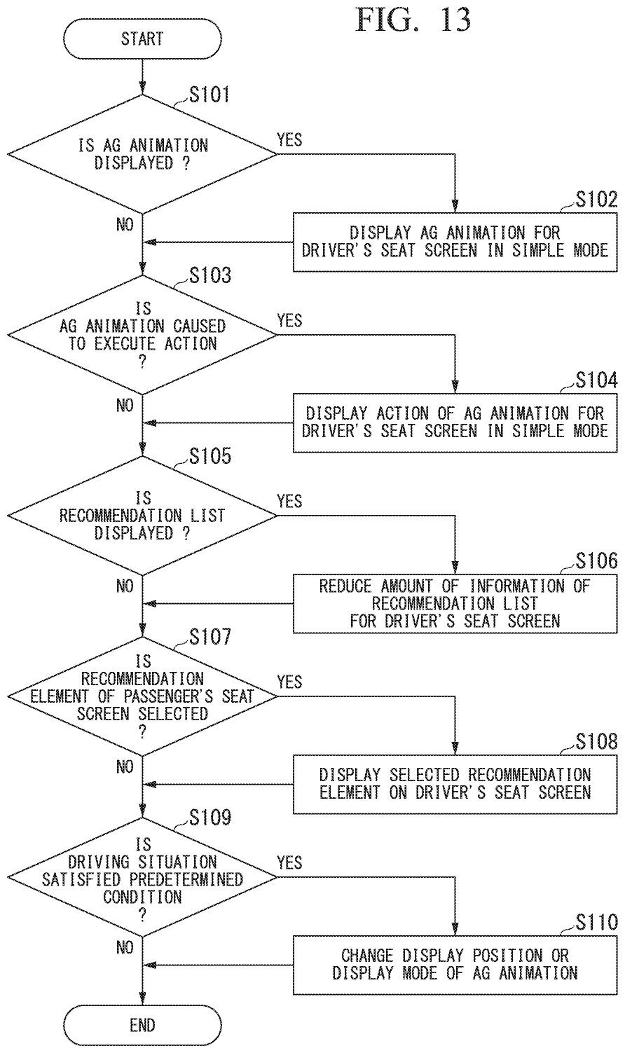

FIG. 13 is a flowchart showing an example of a process performed by the display controller 116. The display controller 116 repeats the following process at predetermined timings.

The display controller 116 determines whether or not to display the AG animation for the driver's seat on the first display 21 or the like (Step S101). When the AG animation for the driver's seat is displayed on the first display 21 or the like, the display controller 116 causes it to be displayed in a simpler mode compared to when the AG animation for the passenger's seat is displayed (Step S102). The display controller 116 determines whether or not to cause the AG animation for the driver's seat to execute an action (Step S103). When the AG animation for the driver's seat is caused to execute an action, the display controller 116 is caused to display it in a simpler mode compared to when the AG animation for the passenger's seat is caused to execute an action (Step S104).

Next, the display controller 116 determines whether or not to display a recommendation list on the first display 21 (Step S105). When a recommendation list is displayed on the first display 21, the display controller 116 displays the recommendation list with a smaller amount of information compared to when the recommendation list is displayed on the second display 22 (Step S106). The display controller 116 determines whether one recommendation element has been selected from the recommendation list displayed on the second display 22 (Step S107). When one recommendation element is selected, the display controller 116 causes the first display 21 to display the selected recommendation element (Step S108).

Next, the display controller 116 determines whether the driving situation satisfies a predetermined condition (Step S109). When the driving situation satisfies a predetermined condition, the display controller 116 changes the display position and display type of the AG animation for the driver's seat and the AG animation for the passenger's seat (Step S110).

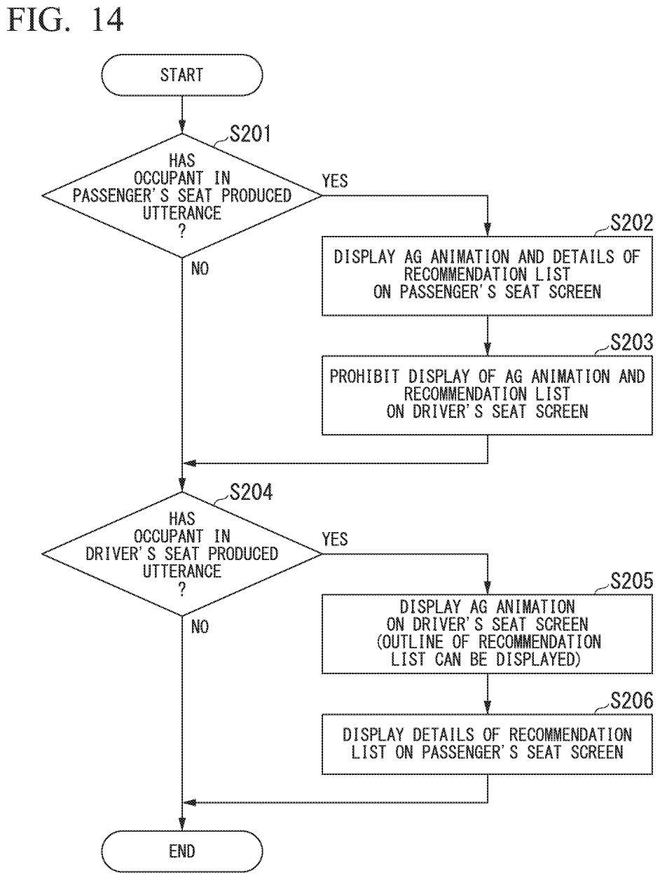

FIG. 14 is a flowchart showing another example of a process performed by the display controller 116. The display controller 116 repeats the following process at predetermined timings. The display controller 116 determines whether the position of the seat of the occupant who has produced the utterance in the host vehicle M is at a passenger's seat (Step S201). When the position of the seat of the occupant who has produced the utterance in the host vehicle M is at a passenger's seat, the display controller 116 causes the second display 22 to display the AG animation and details of the recommendation list (Step S202). Then, the display controller 116 prohibits display of the AG animation and the recommendation list on the first display 21 (Step S203).

On the other hand, in Step S201, when the position of the seat of the occupant who has produced the utterance in the host vehicle M is not at a passenger's seat, the display controller 116 determines whether the position of the seat of the occupant who has produced the utterance in the host vehicle M is at a driver's seat (Step S204). When the position of the seat of the occupant who has produced the utterance in the host vehicle M is at a driver's seat, the display controller 116 causes the first display 21 to display the AG animation (Step S205). In Step S205, the display controller 116 may cause the first display 21 to additionally display the outline of the recommendation. The display controller 116 causes the second display 22 to display details of the recommendation list (Step S206).

According to the agent device 100 of the first embodiment described above, it is possible to realize in-vehicle displays in an appropriate mode when an agent provides a service.

While forms for implementing the present invention have been described above with reference to embodiments, the present invention is not limited to the embodiments at all, and various modifications and substitutions can be made without departing from the spirit and scope of the present invention.

For example, the passenger's seat screen may be displayed on the third display 23.

What is claimed is:

1. An agent device, comprising:
an agent functional unit configured to provide a service including causing an output unit to output a response using a sound, in response to an utterance of an occupant in a vehicle; and
a display controller configured to cause a display provided in the vehicle to display an animation related to an agent corresponding to the agent functional unit,
wherein the display controller is configured to cause the display to display the animation in different types between a case where the animation is displayed in a first display area of the display, and a case where the animation is displayed in a second display area which is different from the first display area.

2. The agent device according to claim 1,
wherein a position of the first display area in the vehicle is closer to a position at which a driver's head is assumed to be located than the second display area.

3. The agent device according to claim 1,
wherein the display controller causes the display to display the animation of the agent in a simpler mode when the animation of the agent is displayed in the first display area than when the animation of the agent is displayed in the second display area.

4. The agent device according to claim 3,
wherein, according to an utterance of the occupant, the display controller causes the display to display an animation of the agent in a simpler mode when the animation of the agent is displayed in the first display area than when the animation of the agent is displayed in the second display area.

5. The agent device according to claim 3,
wherein the simple mode includes a mode with little movement.

6. The agent device according to claim 1,
wherein the display controller changes at least one of a display position and a display type of the animation according to a driving situation of the vehicle.

7. The agent device according to claim 1,
wherein the display controller causes the display to display agent information that is provided in response to an utterance of the occupant, and display the agent information in different types between display in the first display area and display in the second display area.

8. The agent device according to claim 7,
wherein the display controller reduces the amount of information when the agent information is displayed in the first display area compared to when the agent information is displayed in the second display area.

9. The agent device according to claim 7,
wherein, when a part of the agent information displayed in the second display area is designated by the occupant using an operation unit, the display controller changes the display of the first display area to information based on the part of the agent information designated by the occupant.

10. The agent device according to claim 1,
wherein the agent functional unit acquires a seat position of the occupant who has produced the utterance in the vehicle, and
wherein the display controller causes, based on the position of the seat of the occupant who has produced the utterance in the vehicle, the animation to be displayed in a display area closer to a position at which the head of the occupant who has produced the utterance is assumed to be located between the first display area and the second display area.

11. The agent device according to claim 10,
wherein the display controller causes, when the occupant who has produced the utterance is an occupant in a driver's seat, between the first display area and the second display area, more detailed information based on information acquired by the agent functional unit to be displayed in a display area farther from the position at which the head of the occupant who has produced the utterance is assumed to be located than in a display area closer to the position at which the head of the occupant who has produced the utterance is assumed to be located.

12. An agent device control method causing a computer to execute:
providing a service including causing an output unit to output a response using a sound using an agent function, in response to an utterance of an occupant in a vehicle;
causing a display provided in the vehicle to display an animation related to the agent function; and
displaying the animation in different types between a case where the animation is displayed in a first display area of the display and a case where the animation is displayed in a second display area which is different from that of the first display area.

13. A computer readable non-transitory storage medium storing a program causing a computer to execute:
a process of providing a service including causing an output unit to output a response using a sound using an agent function, in response to an utterance of an occupant in a vehicle;
a process of causing a display provided in the vehicle to display an animation related to the agent function; and
a process of displaying the animation in different types between a case where the animation is displayed in a first display area of the display and a case where the animation is displayed in a second display area which is different from the first display area.
